(19) United States
(12) Patent Application Publication
(10) Pub. No.: US 2024/0060778 A1
(43) Pub. Date: Feb. 22, 2024

(54) THREE-AXIS GYROSCOPE

(71) Applicant: AAC Kaitai Technologies (Wuhan) CO., LTD, Wuhan (CN)

(72) Inventors: Zhan Zhan, Shenzhen (CN); Zhao Ma, Shenzhen (CN); Xiao Kan, Shenzhen (CN); Shitao Yan, Shenzhen (CN); Shan Yang, Shenzhen (CN); Veronica Tan, Singapore (SG); Yang Li, Shenzhen (CN); Kahkeen Lai, Singapore (SG)

(21) Appl. No.: 18/088,822

(22) Filed: Dec. 27, 2022

Related U.S. Application Data
(63) Continuation of application No. PCT/CN2022/119632, filed on Sep. 19, 2022.

(30) Foreign Application Priority Data
Aug. 16, 2022 (CN) 202210981204.2

(51) Int. Cl. G01C 19/5712; G01C 19/5733

(52) U.S. Cl. CPC G01C 19/5712; G01C 19/5733

(57) ABSTRACT

The present invention provides a three-axis gyroscope and electronic products, including a drive structure used for driving the three-axis gyroscope, a first sensitive structure used for sensing an angular velocity in a first direction, a second sensitive structure used for sensing an angular velocity in the second direction, a third sensitive structure used for sensing an angular velocity in a third direction. The first sensitive structure, the second sensitive structure and the third sensitive structure can be mutually coupled in the first detection modality, the second detection modality and the third detection modality, which can effectively avoid the coupling error, achieve electrical orthogonal suppression and capacitance modality matching in the first detection modality, the second detection modality or the third detection modality, so that the structural performance loss can be compensated, thus reducing an orthogonal error and improving the detection accuracy and overall performance of the three-axis gyroscope.

### CROSS-REFERENCE TO RELATED APPLICATIONS

The application is a continuation of International Application No. PCT/CN2022/119632 filed on Sep. 19, 2022, which is incorporated herein by reference in its entireties.

### TECHNICAL FIELD

The present invention relates to the technical field of gyroscopes, in particular to a three-axis gyroscope.

### BACKGROUND

A micro-electromechanical system (MEMS) gyroscope in the prior art can detect an angular velocity according to the generation principle of Coriolis force. An angular velocity in any direction can be decomposed along the X axis, the Y axis and the Z axis in a space rectangular coordinate system. A three-axis gyroscope refers to a micromechanical gyroscope with the ability to measure angular velocities in of X, Y and Z axial directions. Therefore, the three-axis gyroscope can measure the direction and size of any angular velocity in a space. However, due to the mutual coupling in motion modalities in the X axis, the Y axis and the Z axis of the traditional three-axis gyroscope, an output of each detected axis will contain a large coupling error, and electrical orthogonal suppression and capacitance modality matching cannot be achieved at the same time. That is, the electrical control of a detection modality of a specific axis will affect the characteristics of the other axial detection modalities.

Therefore, it is necessary to provide a three-axis gyroscope to solve the above problems.

### SUMMARY

The present invention aims to provide a three-axis gyroscope to solve the following problems: the mutual coupling in the motion modalities in the X axis, the Y axis and the Z axis of a three-axis gyroscope electronic product in the prior art causes that an output of each detected axis will contain a large coupling error, and electrical orthogonal suppression and capacitance modality matching cannot be achieved at the same time. The technical scheme of the invention is as follows: the present invention provides a three-axis gyroscope, including a drive structure, a first sensitive structure, a second sensitive structure, a third sensitive structure, and a plurality of anchoring structures used for fixing the drive structure, the first sensitive structure, the second sensitive structure and the third sensitive structure; the drive structure is used for driving the three-axis gyroscope, the first sensitive structure is used for sensing an angular velocity in a first direction; the first sensitive structure is connected with the drive structure through elastic members; the first sensitive structure includes a first mass block and a second mass block which are symmetrically arranged along a second direction; the second sensitive structure is used for sensing an angular velocity in the second direction; the second sensitive structure is connected with the drive structure through elastic members; the second sensitive structure includes a third mass block and a fourth mass block which are symmetrically arranged along the second direction; the third sensitive structure is used for sensing an angular velocity in a third direction; the third sensitive structure is connected with the drive structure through elastic members; the third sensitive structure includes a fifth mass block and a sixth mass block which are symmetrically arranged along the second direction, wherein the first direction, the second direction and the third direction are orthogonal to each other; the three-axis gyroscope has a drive modality, a first detection modality, a second detection modality and a third detection modality; in the drive modality, the drive structure drives the first mass block and the second mass block to move reversely along the second direction; each of the third mass block and the fourth mass block is provided with a rotating shaft having an extending direction parallel to the third direction; the drive structure also drives the third mass block and the fourth mass block to rotate reversely around respective rotating shafts towards the first sensitive structure or the third sensitive structure; the drive structure also drives the fifth mass block and the sixth mass block to move reversely along the second direction; wherein when the third mass block and the fourth mass block rotate towards the fifth mass block and the sixth mass block, the fifth mass block and the sixth mass block are far away from each other, and the first mass block and the second mass block are close to each other; motion directions of the first mass block and the fifth mass block are opposite; in the first detection modality, the drive structure, the second sensitive structure and the third sensitive structure remain stationary, and the opposite sides of the first mass block and the second mass block reversely flip towards the third direction to generate a vibration displacement in the third direction; in the second detection modality, the drive structure, the first sensitive structure and the third sensitive structure remain stationary, and the third mass block and the fourth mass block reversely flip around the respective rotating shafts along the third direction to generate a vibration displacement in the third direction; in the third detection modality, the drive structure, the first sensitive structure and the second sensitive structure remain stationary, and the fifth mass block and the sixth mass block reversely move along the first direction to generate a vibration displacement in the first direction.

In one possible design, the first sensitive structure further includes a first guide portion; the first guide portion is connected to the anchoring structures through the elastic members along the first direction, and the first guide portion is connected to the first mass block or the second mass block through the elastic members along the second direction; in the drive modality, the first guide portion is easily pulled by the first mass block and the second mass block to remain stationary, so as to prevent the first mass block and the second mass block from moving in the same direction along the second direction; and in the first detection modality, the first guide portion is pulled by the first mass block and the second mass block to rotate towards the third direction.

In one possible design, the second sensitive structure further includes a second guide portion; the second guide portion is connected to the anchoring structures through the elastic members along the first direction, and the second guide portion is connected to the third mass block or the fourth mass block through the elastic members along the second direction; in the drive modality, the second guide portion is easily pulled by the third mass block and the fourth mass block to do reciprocating motion along the first direction, so as to prevent the third mass block and the fourth mass block from rotating in the same direction along the third direction; and in the second detection modality, the second guide portion is pulled by the third mass block and the fourth mass block to do reciprocating motion along the third direction.

In one possible design, the third sensitive structure further includes a third guide portion; the third guide portion is symmetrically provided with two first guide blocks along the first direction by taking the second direction as an axis of symmetry, and two second guide blocks along the second direction by taking the first direction as an axis of symmetry; the first guide blocks are connected to the anchoring structures along the second direction through in-plane guide elastic members, and the opposite sides of the two first guide blocks are connected to the two second guide blocks through the elastic members; the second guide blocks are connected to the anchoring structures along the first direction through the in-plane guide elastic members, and the reverse sides of the two second guide blocks are connected to the adjacent fifth mass block or sixth mass block through the elastic members; in the drive modality, the second guide blocks are easily pulled by the fifth mass block and the sixth mass block to reversely move along the second direction, and the first guide blocks are easily pulled by the second guide blocks to reversely move along the first direction, thereby preventing the fifth mass block and the sixth mass block from moving in the same direction.

In one possible design, the third sensitive structure further includes a first detection block and a second detection block which are symmetrically arranged along the second direction; the first detection block is connected to the anchoring structures along the second direction through the in-plane guide elastic members, and is connected to the fifth mass block along the first direction through the elastic member; the second detection block is connected to the anchoring structures along the second direction through the in-plane guide elastic members, and is connected to the sixth mass block along the first direction through the elastic member; in the drive modality, the first detection block and the second detection block remain stationary; in the third detection modality, the first detection block moves with the fifth mass block in the same direction; and the second detection block moves with the sixth mass block in the same direction.

In one possible design, the third sensitive structure further includes two third detection blocks, two fourth detection blocks and two coupling levers which are symmetrically arranged along the first direction by taking the second direction as an axis of symmetry, and the third detection blocks and the fourth detection blocks are symmetrically arranged one by one along the second direction by taking the first direction as an axis of symmetry; along the first direction, one end of each of the two third detection blocks is connected with the fifth mass block through an elastic member, and the other end is connected with each coupling lever through an elastic member; one end of each of the two fourth detection blocks is connected with the sixth mass block through an elastic member, and the other end is connected with each coupling lever through an elastic member; along the second direction, the two third detection blocks and the two fourth detection blocks are connected to the anchoring structures along the second direction through the in-plane guide elastic members; in the drive modality, the third detection blocks and the fourth detection blocks remain stationary; in the third detection modality, the two third detection blocks move in the same direction with the fifth mass block; the two fourth detection blocks move in the same direction with the sixth mass block; and the coupling levers are pulled by the third detection blocks and the fourth detection blocks to rotate in the same direction around rotating shafts of the coupling levers.

In one possible design, the three-axis gyroscope further includes first transducers, second transducers, and third transducers; along the third direction, the first transducers and the first sensitive structure are spaced apart to form capacitance to detect the vibration displacement of the first sensitive structure along the third direction, or to prevent an orthogonal error of the first detection modality, or to match the frequencies of the drive modality and the first detection modality; along the third direction, the second transducers and the second sensitive structure are spaced apart to form capacitance to detect the vibration displacement of the second sensitive structure along the third direction (Z), or to prevent an orthogonal error of the second detection modality, or to match the frequencies of the drive modality and the second detection modality; and in a plane perpendicular to the third direction, the third transducers and the third sensitive structure are located in the same plane, and the third transducers and the third sensitive structure are spaced apart to form capacitance to detect the vibration displacement of the third sensitive structure along the first direction, or to prevent an orthogonal error of the third detection modality, or to match the frequencies of the drive modality and the third detection modality.

In one possible design, the drive structure includes first drive portions, drive arms, and third drive portions, and second drive portions are formed on the drive arms; the first drive portions and the third drive portions are respectively connected to both ends of the drive arms, and are respectively located on both sides of the second drive portions; the first drive portions are connected with the first sensitive structure through elastic members; the second drive portions are connected with the second sensitive structure through elastic members; and the third drive portions are connected with the third sensitive structure through elastic members; the first drive portions and the third drive portions are connected to the anchoring structures through in-plane guide elastic members along the first direction; and the first drive portions and the third drive portions drive the second drive portions to rotate through the elastic members when moving along the second direction.

In one possible design, the drive structure further includes drive electrodes which are mounted on the first drive portions and the second drive portions; and the drive electrodes are spaced apart from the first drive portions and/or the third drive portions to form drive capacitance.

In one possible design, the second sensitive structure further includes rotational guide elastic members; the third mass block and the fourth mass block are provided with hole structures; and the rotational guide elastic members are located in the hole structures.

The beneficial effects of the present invention lie in: the three-axis gyroscope of the present invention has a simple structure and high detection sensitivity. The first sensitive structure, the second sensitive structure and the third sensitive structure are independent of each other, and can be mutually coupled in the first detection modality, the second detection modality and the third detection modality, without interference, so that a large coupling error generated by the coupling of the first sensitive structure, the second sensitive structure and the third sensitive structure during detection of the angular velocities in different directions can be effectively avoided, and the detection accuracy of the three-axis gyroscope is improved. On the other hand, the three-axis gyroscope of this structure can simultaneously achieve electrical orthogonal suppression and capacitance modality matching in the first detection modality, the second detection modality or the third detection modality, so that the structural performance loss caused by asymmetry of machining can be compensated, thus reducing an orthogonal error and improving the detection accuracy and overall performance of the three-axis gyroscope.

It should be understood that the general description above and the detailed description below are only illustrative and do not limit this application.

### BRIEF DESCRIPTION OF THE DRAWINGS

FIG. 1 is a schematic structural diagram of a three-axis gyroscope provided according to the present invention in one embodiment;

FIG. 2 is a schematic structural diagram of the three-axis gyroscope in FIG. 1 in a drive modality;

FIG. 3 is a schematic structural diagram of the three-axis gyroscope in FIG. 1 in a first detection modality;

FIG. 4 is a sectional view of a first sensitive structure in FIG. 3 along direction A-A;

FIG. 5 is a schematic structural diagram of the three-axis gyroscope in FIG. 1 in a second detection modality;

FIG. 6 is a sectional view of a second sensitive structure in FIG. 5 along direction B-B;

FIG. 7 is a schematic structural diagram of the three-axis gyroscope in FIG. 1 in a third detection modality;

FIG. 8 is a schematic structural diagram of a three-axis gyroscope provided according to the present invention in another embodiment;

FIG. 9 is a schematic structural diagram of the three-axis gyroscope in FIG. 8 in a drive modality;

FIG. 10 is a schematic structural diagram of the three-axis gyroscope provided in FIG. 8 in a first detection modality;

FIG. 11 is a sectional view of a first sensitive structure in FIG. 10 along direction C-C;

FIG. 12 is a schematic structural diagram of the three-axis gyroscope in FIG. 8 in a second detection modality;

FIG. 13 is a sectional view of a second sensitive structure in FIG. 12 along direction D-D;

FIG. 14 is a schematic structural diagram of the three-axis gyroscope in FIG. 8 in a third detection modality;

FIG. 15 is a schematic structural diagram of a three-axis gyroscope provided according to the present invention in yet another embodiment;

FIG. 16 is a schematic structural diagram of the three-axis gyroscope in FIG. 15 in a drive modality; and

FIG. 17 is a schematic structural diagram of the three-axis gyroscope in FIG. 15 in a third detection modality.

The accompanying drawings, which are incorporated herein by reference and form a part of this specification, illustrate embodiments consistent with the present application and, together with the description, serve to explain the principles of the present application.

### DETAILED DESCRIPTION OF THE EMBODIMENTS

The present invention is further described below in combination with accompanying drawings and implementations.

The terms used in the embodiments of the present invention are only for the purpose of describing the specific embodiments, and are not intended to limit the present invention. The singular forms of “a”, “said”, and “the” used in the embodiments of the present invention and the claims are also intended to include plural forms, unless the context clearly indicates other meanings.

It should be understood that the term “and/or” herein is only an association relationship that describes associated objects, and represents that there can be three relationships. For example, A and/or B can represent that: A exists alone, A and B exist simultaneously, and B exists alone. In addition, the character “/” herein generally indicates that the front and back associated objects are in an “or” relationship.

It should be noted that the directional terms such as “above”, “below”, “left”, and “right” described in the embodiments of the present invention are described from the angles shown in the drawings, and should not be construed as limiting the embodiments of the present invention. In addition, in this context, it should also be understood that when an element is referred to as being “above” or “below” another element, it can not only be directly connected “above” or “below” another element, but also indirectly connected to the “above” or “below” of another element through an intermediate.

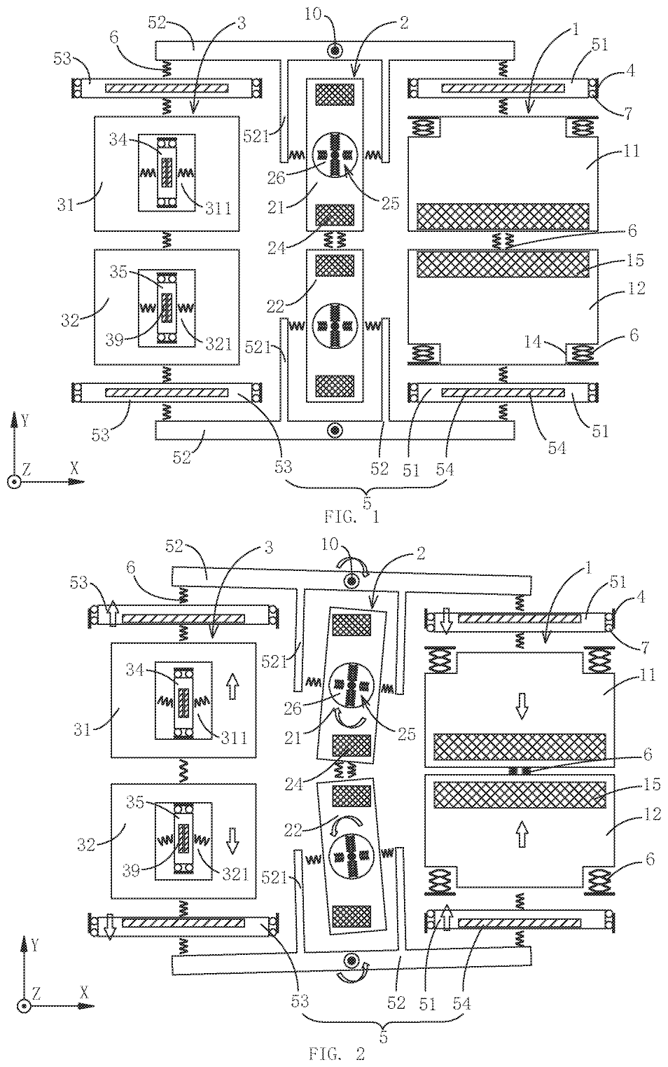

The present invention provides a three-axis gyroscope, as shown in FIG. 1 to FIG. 7, including a drive structure 5, a first sensitive structure 1, a second sensitive structure 2, a third sensitive structure 3, and a plurality of anchoring structures 4 for fixing the drive structure 5, the first sensitive structure 1, the second sensitive structure 2 and the third sensitive structure 3. The drive structure 5 is used for driving the three-axis gyroscope. The first sensitive structure 1 is used for sensing an angular velocity in a first direction X. The first sensitive structure 1 is connected with the drive structure 5 through elastic members 6. The first sensitive structure 1 includes a first mass block 11 and a second mass block 12 which are symmetrically arranged along a second direction Y. The second sensitive structure 2 is used for sensing an angular velocity in the second direction Y. The second sensitive structure 2 is connected with the drive structure 5 through elastic members 6. The second sensitive structure 2 includes a third mass block 21 and a fourth mass block 22 which are symmetrically arranged along the second direction Y. The third sensitive structure 3 is used for sensing an angular velocity in a third direction Z. The third sensitive structure 3 is connected with the drive structure 5 through elastic members 6. The third sensitive structure 3 includes a fifth mass block 31 and a sixth mass block 32 which are symmetrically arranged along the second direction Y.

The first direction X, the second direction Y and the third direction Z are orthogonal to each other. The three-axis gyroscope has a drive modality, a first detection modality, a second detection modality and a third detection modality.

In the drive modality as shown in FIG. 2, the drive structure 5 can drive the first mass block 11 and the second mass block 12 of the first sensitive structure 1 to move reversely in a reciprocating manner along the second direction Y through the elastic members 6, causing differential linear motion between the first mass block 11 and the second mass block 12. Each of the third mass block 21 and the fourth mass block 22 is provided with a rotating shaft with an extending direction parallel to the third direction Z. The drive structure 5 can also drive the third mass block 21 and the fourth mass block 22 of the second sensitive structure 2 to rotate reversely around their own rotating shafts towards the first sensitive structure 1 or the third sensitive structure 3 through the elastic members 6, causing differential rotation motion between the third mass block 21 and the fourth mass block 22. Meanwhile, the drive structure 5 can also drive the fifth mass block 31 and the sixth mass block 32 of the third sensitive structure 3 to move reversely in a reciprocating manner along the second direction Y through the elastic members 6, causing differential linear motion between the fifth mass block 31 and the sixth mass block 32. When the third mass block 21 and the fourth mass block 22 rotate towards the fifth mass block and the sixth mass block, the fifth mass block and the sixth mass block are far away from each other, and the first mass block and the second mass block are close to each other. Motion directions of the first mass block 11 and the fifth mass block 31 are opposite.

When the three-axis gyroscope receives an externally applied angular velocity along the first direction X, the second direction Y or the third direction Z, the first sensitive structure 1, the second sensitive structure 2 or the third sensitive structure 3 generates a Coriolis force due to the angular velocity according to the Coriolis principle, and the Coriolis force will force the first sensitive structure 1, the second sensitive structure 2 or the third sensitive structure 3 of the three-axis gyroscope to generate a vibration perpendicular to its motion direction in the drive modality to make the three-axis gyroscope in the first detection modality, the second detection modality or the third detection modality. By means of detecting the vibration displacement of the first sensitive structure 1, the second sensitive structure 2 or the third sensitive structure 3, and transmitting the detected structure to a computing system (not shown in the figure), the computing system calculates the angular velocity applied to the three-axis gyroscope according to the received data.

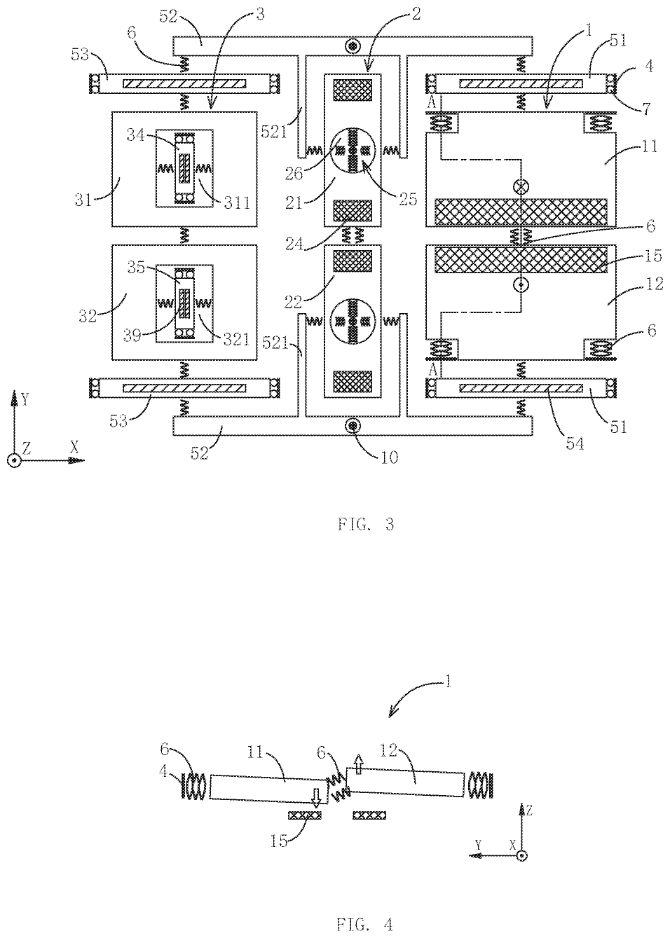

Specifically, when the three-axis gyroscope is subjected to the angular velocity along the first direction X, the three-axis gyroscope is in the first detection modality as shown in FIG. 3 and FIG. 4. In the first detection modality, the drive structure 5, the second sensitive structure 2 and the third sensitive structure 3 can remain stationary. The first sensitive structure 1 generates a Coriolis force along the third direction Z due to the impact of the angular velocity along the first direction X. The direction of the Coriolis force at certain time is shown in the arrow directions in FIG. 3 and FIG. 4. The Coriolis force will force the opposite sides of the first mass block 11 and the second mass block 12 to reversely flip towards the third direction Z, causing differential rotation motion between the first mass block 11 and the second mass block 12, thus generating the vibration displacement in the third direction Z. The angular velocity along the first direction X can be acquired by means of detecting the vibration displacements of the first mass block 11 and the second mass block in the third direction.

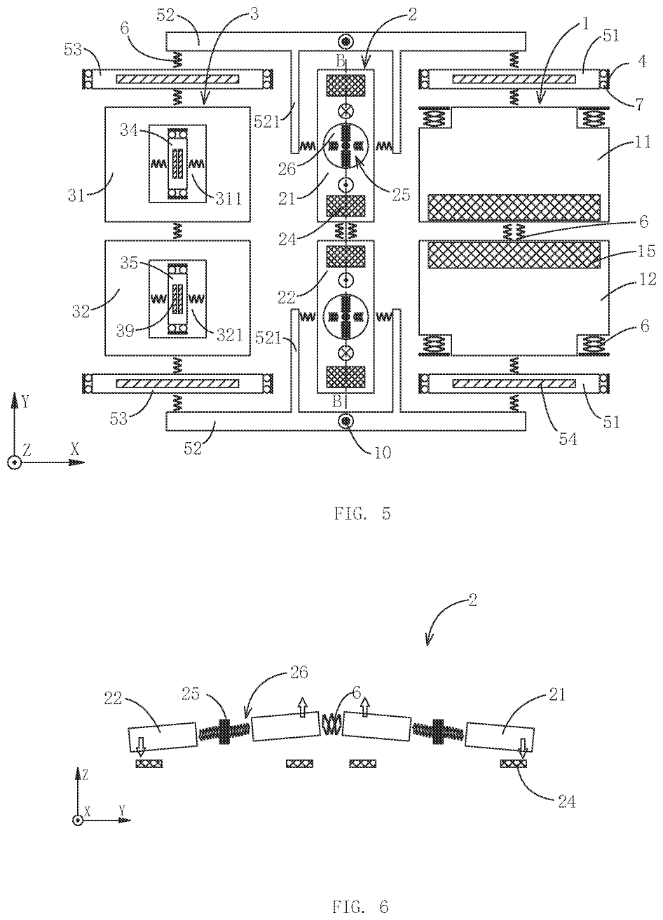

When the three-axis gyroscope is subjected to the angular velocity along the second direction Y, the three-axis gyroscope is in the second detection modality as shown in FIG. 5 and FIG. 6. In the second detection modality, the drive structure 5, the first sensitive structure 1 and the third sensitive structure 3 can remain stationary. The second sensitive structure 2 generates a Coriolis force along the third direction Z due to the impact of the angular velocity along the second direction Y. The direction of the Coriolis force at certain time is shown in the arrow directions in FIG. 5 and FIG. 6. The Coriolis force will force the third mass block 21 and the fourth mass block 22 to reversely flip around their own rotating shafts along the third direction Z, causing differential rotation motion between the third mass block 21 and the fourth mass block 22, thus generating the vibration displacement in the third direction Z. The angular velocity along the second direction Y can be acquired by means of detecting the vibration displacements of the third mass block 21 and the fourth mass block 22 along the third direction.

When the three-axis gyroscope is subjected to the angular velocity along the third direction Z, the three-axis gyroscope is in the third detection modality as shown in FIG. 7. In the third detection modality, the drive structure 5, the first sensitive structure 1 and the third sensitive structure 2 can remain stationary. The third sensitive structure 3 generates a Coriolis force along the first direction X due to the impact of the angular velocity along the third direction Z. The direction of the Coriolis force at certain time is shown in the arrow direction FIG. 7. The Coriolis force will force the fifth mass block 31 and the sixth mass block 32 to reversely move in a reciprocating manner along the first direction X, causing differential linear motion between the fifth mass block 31 and the sixth mass block 32, thus generating the vibration displacement in the first direction X. The angular velocity along the second direction Y can be acquired by means of detecting the displacement along the first direction X.

Therefore, the three-axis gyroscope of the present invention has a simple structure and high detection sensitivity. The first sensitive structure 1, the second sensitive structure 2 and the third sensitive structure 3 are independent of each other, and can be mutually coupled in the first detection modality, the second detection modality and the third detection modality, without interference, so that a large coupling error generated by the coupling of the first sensitive structure 1, the second sensitive structure 2 and the third sensitive structure 3 during detection of the angular velocities in different directions can be effectively avoided, and the detection accuracy of the three-axis gyroscope is improved. On the other hand, the three-axis gyroscope of this structure can simultaneously achieve electrical orthogonal suppression and capacitance modality matching in the first detection modality, the second detection modality or the third detection modality, so that the structural performance loss caused by asymmetry of machining can be compensated, thus reducing an orthogonal error and improving the detection accuracy and overall performance of the three-axis gyroscope.

In addition, the gyroscope of the present invention is symmetrically arranged in the second direction Y, and the first sensitive structure 1, the second sensitive structure 2 and the third sensitive structure 3 in the drive modality, the first detection modality, the second detection modality and the third detection modality are all in differential motions, which can effectively improve the stability of the motion of the three-axis gyroscope and facilitate differential detection, and can effectively prevent the influence of common mode interferences such as acceleration and impact to further improve the overall performance of the three-axis gyroscope.

In one specific embodiment, as shown in FIG. 2 to FIG. 4, the first mass block 11 and the second mass block 12 are connected through an elastic member 6, so that the first mass block 11 and the second mass block 12 can be coupled with each other. In the drive modality as shown in FIG. 2, the elastic member 6 between the first mass block 11 and the second mass block 12 can drive the first mass block 11 and the second mass block 12 to move along the second direction Y with the drive structure 5, thus deforming along the second direction Y, and the reciprocating differential linear motion can be formed between the first mass block 11 and the second mass block 12. In the first detection modality as shown in FIG. 3 and FIG. 4, the elastic member 6 can deform when the first mass block 11 and the second mass block 12 reversely flip under the action of the Coriolis force, so that the first mass block 11 and the second mass block 12 can pull each other to do differential rotation motion in a plane perpendicular to the first direction X, which is convenient for realizing differential detection and improves the motion stability of the first mass block 11 and the second mass block 12.

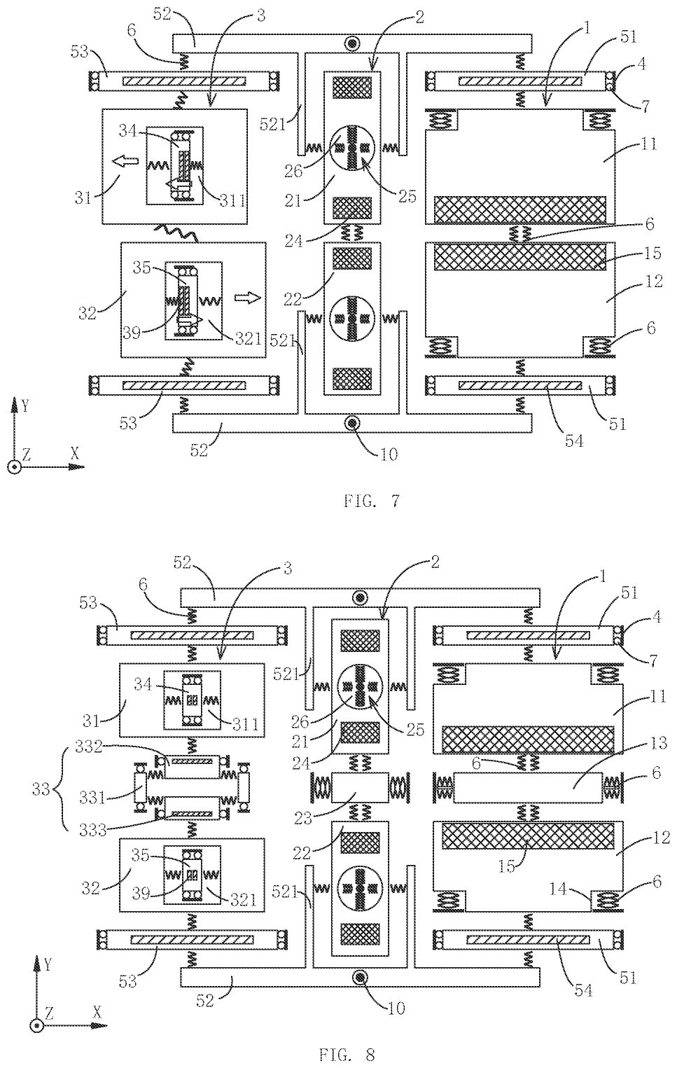

In another specific embodiment, as shown in FIG. 8 to FIG. 11, the first sensitive structure 1 can also include a first guide portion 13. The first guide portion 13 is connected to the anchoring structures 4 through the elastic members 6 along the first direction X, and the first guide portion 13 is connected to the first mass block 11 or the second mass block 12 through the elastic member 6 along the second direction Y.

In the drive modality, the first guide portion 13 is easily pulled by the first mass block 11 and the second mass block 12 to remain stationary, so as to prevent the first mass block 11 and the second mass block 12 from moving in the same direction along the second direction Y.

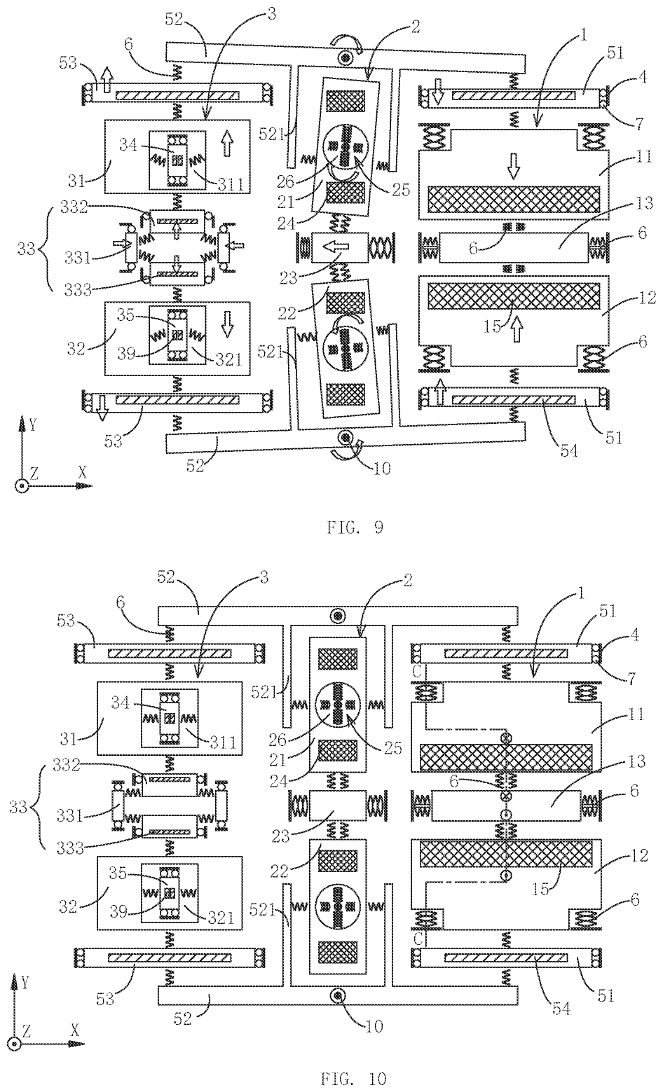

In the first detection modality as shown in FIG. 10 and FIG. 11, the first guide portion 13 can be pulled by the first mass block 11 and the second mass block 12 to rotate towards the third direction Z. The force directions of the first guide portion 13 at certain time are represented by the arrow directions in FIG. 9, FIG. 10 and FIG. 11.

In this embodiment, the elastic member 6 is a structure that can rotate around the first direction X, and is hard to deform in the first direction X, the second direction Y or the third direction Z. Two ends of the first guide portion 13 along the first direction X are connected to the anchoring structures 4 through the elastic members 6, so that the first guide portion 13 can rotate in a plane perpendicular to the first direction X, and can be prevented from moving in the second direction Y.

In the drive modality as shown in FIG. 9, the two ends of the first guide portion 13 along the second direction Y will not move with the motion of the first mass block 11 or the second mass block 12, so that the first mass block 11 and the second mass block 12 can simultaneously do the differential linear motion towards or away from the first guide portion 13 under the drive of the drive structure 5, thus reducing the motion interference between the first mass block 11 and the second mass block 12, and avoiding the first mass block 11 and the second mass block 12 from moving in the same direction in the drive modality due to the mutual interference or the interference of the drive structure 5 to make the three-axis gyroscope in a parasitic modality. In the first detection modality as shown in FIG. 10 and FIG. 11, the first guide portion 13 can increase a displacement difference in the third direction Z between the first mass block 11 and the second mass block 12, which is more convenient for differential detection and improves the detection accuracy of the three-axis gyroscope.

Therefore, the arrangement of the first guide portion 13 can prevent the first mass block 11 and the second mass block 12 from moving in the same direction along the second direction Y, increase a frequency difference between the drive modality and the parasitic modality, reduce linear impact, vibration interference and other interferences in the same direction output by the first sensitive structure 1, and effectively improve the quality factor of the three-axis gyroscope in the drive modality.

In one specific embodiment, as shown in FIG. 2, FIG. 5 and FIG. 6, the third mass block 21 and the fourth mass block 22 are connected through an elastic member 6, so that the third mass block 21 and the fourth mass block 22 can be coupled with each other. In the drive modality as shown in FIG. 2, the elastic member 6 between the third mass block 21 and the fourth mass block 22 can deform with the rotation of the third mass block 21 and the fourth mass block 22, so that the differential rotation motion in the plane perpendicular to the first direction X can be formed between the third mass block 21 and the fourth mass block 22. In the second detection modality as shown in FIG. 5 and FIG. 6, the elastic member 6 can deform when the third mass block 21 and the fourth mass block 22 reversely flip under the action of the Coriolis force, so that the third mass block 21 and the fourth mass block 22 can pull each other to do differential rotation motion in the plane perpendicular to the first direction X, which is convenient for realizing differential detection and improves the motion stability of the third mass block 21 and the fourth mass block 22.

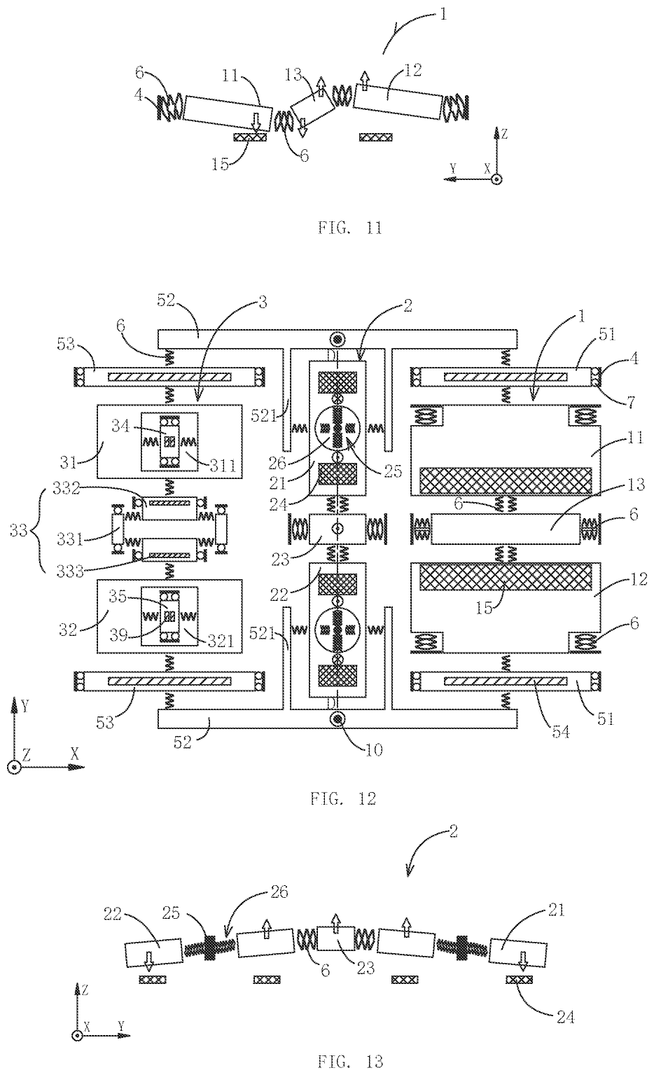

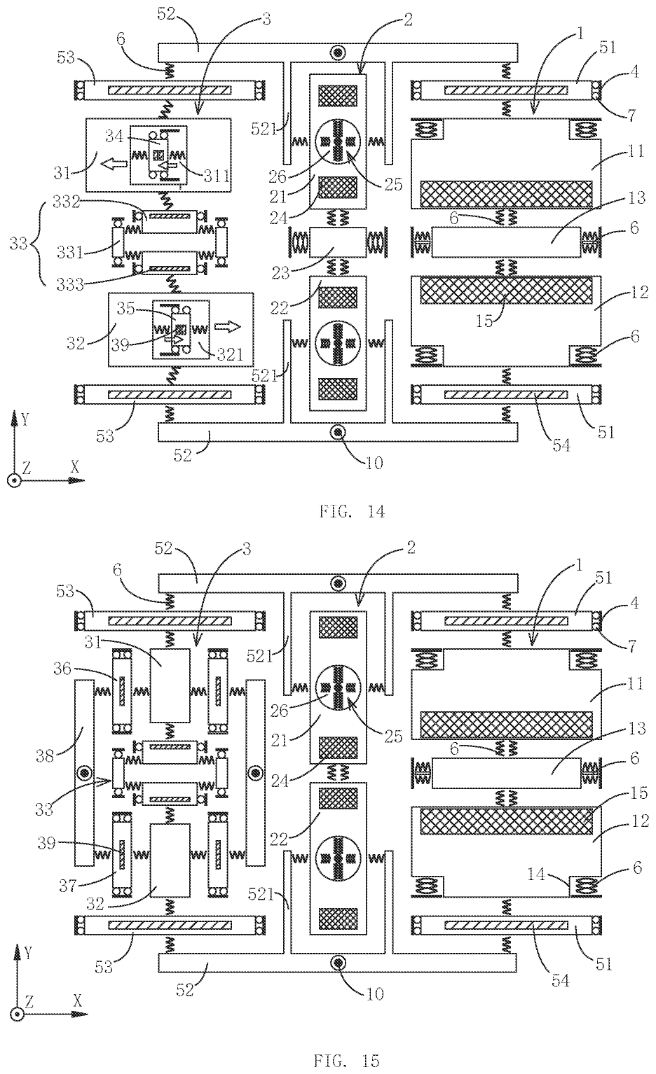

In another specific embodiment, as shown in FIG. 9, FIG. 12 and FIG. 13, the second sensitive structure 2 can also include a second guide portion 23. The second guide portion 23 is connected to the anchoring structures 4 through the elastic members 6 along the first direction X, and the second guide portion 23 is connected to the third mass block 21 or the fourth mass block 22 through the elastic member 6 along the second direction Y.

In the drive modality, the second guide portion 23 is easily pulled by the third mass block 21 and the fourth mass block 22 to do reciprocating motion along the first direction X, so as to prevent the third mass block 21 and the fourth mass block 22 from rotating in the same direction along the third direction Z.

In the second detection modality, the second guide portion 23 can be pulled by the third mass block 21 and the fourth mass block 22 to do reciprocating motion along the third direction Z. The force directions of the second guide portion 23 at certain time are represented by the arrow directions in FIG. 9, FIG. 12 and FIG. 13.

In this embodiment, the elastic member 6 is a structure that can deform along the first direction X and can also rotate towards the third direction Z. Two ends of the second guide portion 23 along the first direction X are connected to the anchoring structures 4 through the elastic members 6.

In the drive modality as shown in FIG. 9, two ends of the second guide portion 23 along the second direction Y can be pulled by the third mass block 21 and the fourth mass block 22 to generate reciprocating motion along the first direction X, while the second guide portion 23 can also guide the third mass block 21 and the fourth mass block 22 to rotate towards the same side, so that the rotation directions of the third mass block 21 and the fourth mass block 22 are different (for example, the third mass block 21 rotates clockwise, and the fourth mass block 22 rotates anticlockwise) to form the differential rotation motion, thus avoiding the third mass block 21 and the fourth mass block 22 from rotating in the same direction in the drive modality due to the interference of the drive structure 5 to make the three-axis gyroscope in the parasitic modality. Furthermore, in the second detection modality as shown in FIG. 12 and FIG. 13, the second guide portion 23 can increase a displacement difference in the third direction Z between the third mass block 21 and the fourth mass block 22, which is more convenient for differential detection and improves the detection accuracy of the three-axis gyroscope.

Therefore, the arrangement of the second guide portion 23 can prevent the third mass block 21 and the fourth mass block 22 from rotating in the same direction in the plane perpendicular to the third direction Z, increase a frequency difference between the drive modality and the parasitic modality, reduce linear impact, vibration interference and other interferences in the same direction output by the second sensitive structure 2, and effectively improve the quality factor of the three-axis gyroscope in the drive modality.

In one specific embodiment, as shown in FIG. 2 and FIG. 7, the fifth mass block 31 and the sixth mass block 32 are connected through an elastic member 6, so that the fifth mass block 31 and the sixth mass block 32 can be coupled with each other. In the drive modality as shown in FIG. 2, the elastic member 6 between the fifth mass block 31 and the sixth mass block 32 can drive the fifth mass block 31 and the sixth mass block 32 to move along the second direction Y with the drive structure 5, thus deforming along the second direction Y, and the reciprocating differential linear motion can be formed between the fifth mass block 31 and the sixth mass block 32. In the third detection modality as shown in FIG. 7, the elastic member 6 can deform when the fifth mass block 31 and the sixth mass block 32 move along the first direction X under the action of the Coriolis force, so that the fifth mass block 31 and the sixth mass block 32 can pull each other to do differential linear motion in the first direction X, which is convenient for realizing differential detection and improves the motion stability of the fifth mass block 31 and the sixth mass block 32.

In another specific embodiment, as shown in FIG. 9 and FIG. 14, the third sensitive structure 3 can also include a third guide portion 33. The third guide portion 33 is symmetrically provided with two first guide blocks 331 along the first direction X by taking the second direction Y as an axis of symmetry, and two second guide blocks 332 along the second direction Y by taking the first direction X as an axis of symmetry. The first guide blocks 331 are connected to the anchoring structures 4 along the second direction Y through in-plane guide elastic members 7, and the opposite sides of the two first guide blocks 331 are respectively connected to the two second guide blocks 332 through the elastic members 6. The second guide blocks 332 are connected to the anchoring structures 4 along the first direction X through the in-plane guide elastic members 7, and the reverse sides of the two second guide blocks 332 are connected to the adjacent fifth mass block 31 or sixth mass block 32 through the elastic members 6.

In the drive modality as shown in FIG. 9, the second guide blocks 332 are easily pulled by the fifth mass block 31 and the sixth mass block 32 to reversely move along the second direction Y, and the first guide blocks 331 are easily pulled by the second guide blocks 332 to reversely move along the first direction X, thereby preventing the fifth mass block 31 and the sixth mass block 32 from moving in the same direction. The force directions of the third guide portion 33 at certain time are as shown in FIG. 9 and FIG. 14.

In this embodiment, the first guide blocks 331 are connected to the anchoring structures 4 along the second direction Y through in-plane guide elastic members 7, so that the first guide blocks 331 can linearly move along the first direction X and be prevented from moving along the second direction Y. The second guide blocks 332 are connected to the anchoring structures 4 along the first direction X through in-plane guide elastic members 7, so that the second guide blocks 331 can linearly move along the second direction Y and be prevented from moving along the first direction.

In the drive modality as shown in FIG. 9, the two second guide blocks 332 move in the same direction with the fifth mass block 31 or the sixth mass block 32 connected to the second guide blocks, and pull the two first guide blocks 331 to be close to each other or far away from each other through the elastic members 6, so that the fifth mass block 31 and the sixth mass block 32 can reversely do differential linear motion along the second direction Y under the drive of the drive structure 5, thus reducing the motion interference between the fifth mass block 31 and the sixth mass block 32, and avoiding the fifth mass block 31 and the sixth mass block 32 from moving in the same direction in the drive modality due to the mutual interference or the interference of the drive structure 5 to make the three-axis gyroscope in a parasitic modality. Furthermore, in the third detection modality as shown in FIG. 14, the third guide portion 33 can remain stationary, which reduces a coupling error of the third sensitive structure 3 in different modalities and can further reduce the motion interference between the fifth mass block 31 and the sixth mass block 32, so that it is more convenient for realizing differential detection and improving the detection accuracy of the three-axis gyroscope.

Therefore, the arrangement of the third guide portion 33 can prevent the fifth mass block 31 and the sixth mass block 32 from moving in the same direction along the second direction Y, increase a frequency difference between the drive modality and the parasitic modality, reduce linear impact, vibration interference and other interferences in the same direction output by the third sensitive structure 3, and effectively improve the quality factor of the three-axis gyroscope in the drive modality.

According to the specific embodiments in FIG. 9 and FIG. 14, the two second guide blocks 332 can be respectively provided with actuators 333 to drive the second guide blocks 332, which further prevents the fifth mass block 31 and the sixth mass block 32 from moving in the same direction. Of course, the actuators 333 may not be provided. This will not be limited here.

It should be noted that the three-axis gyroscope in the present invention can be provided with one or more of the first guide portion 13, the second guide portion 23 and/or the third guide portion 33, or may not be provided with any guide portion. This will not be limited here.

In one specific embodiment, as shown in FIG. 1 to FIG. 14, the third sensitive structure 3 further includes a first detection block 34 and a second detection block 35 which are symmetrically arranged along the second direction Y. The first detection block 34 is connected to the anchoring structures 4 along the second direction Y through the in-plane guide elastic members 7, and is connected to the fifth mass block 31 along the first direction X through the elastic member 6. The second detection block 35 is connected to the anchoring structures 4 along the second direction Y through the in-plane guide elastic members 7, and is connected to the sixth mass block 32 along the first direction X through the elastic member 6.

In the drive modality as shown in FIG. 2 and FIG. 9, the first detection block 34 and the second detection block 35 remain stationary.

In the third detection modality as shown in FIG. 7 and FIG. 14, the first detection block 34 can move in the same direction with the fifth mass block 31. The second detection block 35 can move in the same direction with the sixth mass block 32.

In this embodiment, the first detection block 34 and the second detection block 35 are connected to the anchoring structures 4 along the second direction Y through the in-plane guide elastic members 7, so that the first detection block 34 and the second detection block 35 can linearly move along the first direction X, and be prevented from moving along the second direction Y.

Therefore, in the drive modality as shown in FIG. 2 and FIG. 9, the first detection block 34 and the second detection block 35 can remain stationary. In the third detection modality as shown in FIG. 7 and FIG. 14, the first detection block 34 can slide in the same direction with the fifth mass block 31 along the first direction X, and the second detection block 35 can slide in the same direction with the sixth mass block 32 along the first direction X, so that differential linear motion is formed between the first detection block 34 and the second detection block 35. The angular velocity along the third direction Z can be acquired by means of detecting the vibration displacements of the first detection block 34 and the second detection block 35 in the first direction X. The first detection block 34 and the second detection block 35 have vibration frequencies equal to the motion frequencies of the fifth mass block 31 and the sixth mass block 32, have smaller volumes, and are easier to measure. In addition, this structure can reduce the coupling errors of the first detection block 34 and the second detection block 35 in different modalities and improve the detection accuracy of the three-axis gyroscope.

The first detection block 34 and the second detection block 35 can be respectively arranged on outer sides of the fifth mass block 31 and the sixth mass block 32, or can be arranged on inner sides of the fifth mass block 31 and the sixth mass block 32 in the specific embodiments as shown in FIG. 7 to FIG. 14. This will not be limited here.

Specifically, according to the specific embodiments as shown in FIG. 7 to FIG. 14, when the first detection block 34 and the fifth detection block 35 are respectively arranged on the inner sides of the fifth mass block 31 and the sixth mass block 32, the fifth mass block 31 can be provided with a first sunken portion 311, and the sixth mass block 32 can be provided with a second sunken portion 321, so that the first detection block 34 is mounted to the first sunken portion 311, and the second detection block 35 is mounted to the second sunken portion 321.

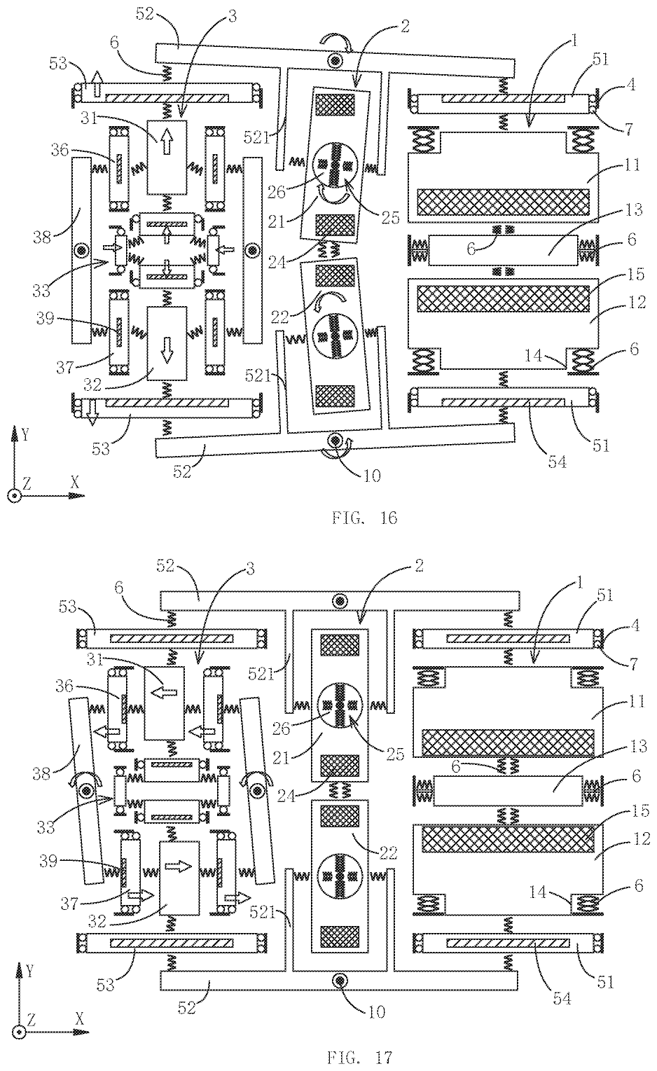

In another specific embodiment, as shown in FIG. 15 to FIG. 17, the third sensitive structure 3 further includes two third detection blocks 36, two fourth detection blocks 37 and two coupling levers 38 which are symmetrically arranged along the first direction X by taking the second direction Y as an axis of symmetry, and the third detection blocks 36 and the fourth detection blocks 37 are symmetrically arranged one by one along the second direction Y by taking the first direction X as an axis of symmetry. Along the first direction X, one end of each of the two third detection blocks 36 is connected with the fifth mass block 31 through an elastic member 6, and the other end is connected with each coupling lever 38 through an elastic member 6. One end of each of the two fourth detection blocks 37 is connected with the sixth mass block 32 through an elastic member 6, and the other end is connected with each coupling lever 38 through an elastic member 6. Along the second direction Y, the two third detection blocks 36 and the two fourth detection blocks 37 are connected to the anchoring structures 4 along the second direction Y through in-plane guide elastic members 7.

In the drive modality as shown in FIG. 16, the third detection blocks 36 and the fourth detection blocks 37 remain stationary.

In the third detection modality as shown in FIG. 17, the two third detection blocks 36 can move in the same direction with the fifth mass block 31. The two fourth detection blocks 37 can move in the same direction with the sixth mass block 32. The coupling levers 38 can be pulled by the third detection blocks 36 and the fourth detection blocks 37 to rotate in the same direction around rotating shafts of the coupling levers.

In this embodiment, the two third detection blocks 36 are independent of each other, and the two fourth detection blocks 37 are independent of each other. The coupling levers 38 are simultaneously coupled with the mutually independent third detection blocks 36 and fourth detection blocks 37. The fifth mass block, the third detection blocks 36, the coupling levers 38, the fourth detection blocks 37, and the sixth mass block 37 are connected in sequence along a circumferential direction through the elastic members 6.

In the drive modality as shown in FIG. 16, the third detection blocks 36, the fourth detection blocks 37 and the coupling levers can remain stationary. In the third detection modality as shown in FIG. 17, the two third detection blocks 36, the two fourth detection blocks 37 and the two coupling levers 38 are pulled to move by the fifth mass block 31 and the sixth mass block 32, and the two third detection blocks 36, the two fourth detection blocks 37 and the two coupling levers 38 have the same motion frequencies as the fifth mass block 31 and the sixth mass block 32. Furthermore, the two coupling levers 38 have the same phase, and the third detection blocks 36 and the fourth detection blocks 37 have opposite phases, so that the degree of symmetry of a differential signal of the third sensitive structure 3 in the third detection modality can be effectively increased, the influence of common mode interference is reduced, and the detection accuracy of the three-axis gyroscope is further improved.

Centers of the two coupling levers 38 can be fixed by fixing members 10, so that the coupling levers 38 can rotate around their rotating shafts, which is convenient for realizing associated motion between all the components of the third sensitive structure 3 and improves the structural stability of the three-axis gyroscope.

In one specific embodiment, as shown in FIG. 1, FIG. 8 and FIG. 15, the first sensitive structure 1 further includes the elastic members 6. Two ends of the first sensitive structure 1 along the second direction Y are also provided with connection portions 14. The connection portions 14 are fixed to the anchoring structures 4 through the elastic members 6.

In this embodiment, each elastic member 6 is a structure that can deform along the first direction X and can also rotate towards the third direction Z, which is convenient for realizing the differential linear motion of the first sensitive structure 1 along the second direction Y in the driving modality as shown in FIG. 2, FIG. 9 and FIG. 16, and is also convenient for realizing that in the first detection modality of the first sensitive structure 1 as shown in FIG. 3, FIG. 4, FIG. 10 and FIG. 11, the opposite sides of the first mass block 11 and the second mass block 12 can reversely flip towards the third direction Z, causing the differential rotation motion between the first mass block 11 and the second mass block 12, thus generating the vibration displacement in the third direction Z. Thus, it is convenient for realizing differential detection. Moreover, the structure is simple, and the structural complexity of the three-axis gyroscope can be reduced.

In one specific embodiment, as shown in FIG. 1, FIG. 8 and FIG. 15, the three-axis gyroscope further includes first transducers 15, second transducers 24, and third transducers 39.

As shown in FIG. 4 and FIG. 11, along the third direction Z, the first transducers 15 and the first sensitive structure 1 are spaced apart to form capacitance to detect the vibration displacement of the first sensitive structure 1 along the third direction Z, or to prevent an orthogonal error of the first detection modality, or to match the frequencies of the drive modality and the first detection modality.

As shown in FIG. 6 and FIG. 13, along the third direction Z, the second transducers 24 and the second sensitive structure 2 are spaced apart to form capacitance to detect the vibration displacement of the second sensitive structure 2 along the third direction Z, or to prevent an orthogonal error of the second detection modality, or to match the frequencies of the drive modality and the first detection modality.

As shown in FIG. 7, FIG. 14 and FIG. 17, in a plane perpendicular to the third direction Z, the third transducers 39 and the third sensitive structure 3 are located in the same plane, and the third transducers 39 and the third sensitive structure 3 are spaced apart to form capacitance to detect the vibration displacement of the third sensitive structure 3 along the first direction X, or to prevent an orthogonal error of the third detection modality, or to match the frequencies of the drive modality and the third detection modality.

In this embodiment, along the third direction Z, the first transducers 15 are located above or below the first sensitive structure 1, with a space, and the second transducers 24 are located above or below the second sensitive structure 2, with a space, so that an arrangement area of the first transducers 15 and the second transducers 24 can be enlarged, which can effectively increase the electromechanical coupling coefficient detected by the three-axis gyroscope and is convenient for detecting the vibration displacements of the first sensitive structure 1 and the second sensitive structure 2 along the third direction Z, thus improving the detection accuracy of the three-axis gyroscope and further reducing a detection error. The third transducers 39 and the third sensitive structure are located on the same plane, which is convenient for detecting the vibration displacement of the third sensitive structure 3 along the first direction X, thus reducing a detection error and improving the detection accuracy of the three-axis gyroscope.

The transducers of the first sensitive structure 1, the second sensitive structure 2 and the third sensitive structure 3 of the three-axis gyroscope in the present invention are independent of each other, which is convenient for realizing electrical orthogonal suppression, reducing the orthogonal errors of the first sensitive structure 1, the second sensitive structure 2 and the third sensitive structure 3 in the detection modalities, and improving the detection accuracy of the three-axis gyroscope.

As shown in FIG. 4 and FIG. 11, the capacitance is formed between the first transducers 15 and the first sensitive structure 1. As shown in FIG. 6 and FIG. 13, the capacitance is formed between the second transducers 24 and the second sensitive structure 2. As shown in FIG. 7, FIG. 14 and FIG. 17, the capacitance is formed between the third transducers 39 and the third sensitive structure 3.

In this embodiment, in the first detection modality as shown in FIG. 4 and FIG. 11, the first sensitive structure 1 senses the angular velocity along the first direction X. The first mass block 11 and the second mass block 12 move along the third direction Z under the action of the Coriolis force. If the first transducers 15 arranged above or below the first mass block 11 and the second mass block 12 along the third direction Z sense that a distance between the first mass block 11 and the second mass block 12 changes, the capacitance of the first transducers 15 will change. The value of the angular velocity along the first direction X can be obtained by means of detecting a changing value of the capacitance.

In the second detection modality as shown in FIG. 6 and FIG. 13, the second sensitive structure 2 senses the angular velocity along the second direction Y. The third mass block 21 and the fourth mass block 22 move along the third direction Z under the action of the Coriolis force. If the second transducers 24 arranged above or below the third mass block 21 and the fourth mass block 22 along the third direction Z sense that a distance between the third mass block 21 and the fourth mass block 22 changes, the capacitance of the second transducers 24 will change. The value of the angular velocity along the second direction Y can be obtained by means of detecting a changing value of the capacitance.

In the third detection modality as shown in FIG. 7, FIG. 14 and FIG. 17, the third sensitive structure 3 senses the angular velocity along the third direction Z. The fifth mass block 31 and the sixth mass block 32 move along the first direction X under the action of the Coriolis force, so that the fifth mass block 31 drives the first detection block 34 or the third detection blocks 36 to move along the first direction X, and the sixth mass block 32 drives the second detection block 35 or the fourth detection blocks 37 to move along the first direction X. If the third transducers 39 sense that distances from the first detection block 34, the second detection block 35, the third detection blocks 36 or the fourth detection blocks 37 change, the capacitance of the third transducers 39 will change. The value of the angular velocity along the third direction Z can be obtained by means of detecting a changing value of the capacitance.

Therefore, the capacitance is convenient for realizing the capacitance modality matching for the first sensitive structure 1, the second sensitive structure 2 and the third sensitive structure 3, which further improves the detection accuracy and stability of the three-axis gyroscope.

In one specific embodiment, as shown in FIG. 1, FIG. 8 and FIG. 15, the drive structure 5 includes first drive portions 51, drive arms 52, and third drive portions 53, and second drive portions 521 are formed on the drive arms 52. The first drive portions 51 and the third drive portions 53 are respectively connected to both ends of the drive arms 52, and are respectively located on both sides of the second drive portions 521. The first drive portions 51 are connected with the first sensitive structure 1 through elastic members 6. The second drive portions 521 are connected with the second sensitive structure 2 through elastic members 6. The third drive portions 53 are connected with the third sensitive structure 3 through elastic members 6. The first drive portions 51 and the third drive portions 53 are connected to the anchoring structures 4 through in-plane guide elastic members 7 along the first direction X. As shown in FIG. 2, FIG. 9 and FIG. 16, the first drive portions 51 and the third drive portions 53 drive the second drive portions 521 to rotate through the elastic members 6 when sliding along the second direction Y.

In this embodiment, the first drive portions 51, the second drive portions 521 and the third drive portions 53 in the drive structure 5 are symmetric along the second direction Y, and the motions between the first drive portions 51, the second drive portions 521 and the third drive portions 53 are associated and have the same frequency. Furthermore, symmetric portions of the first drive portions 51, the second drive portions 521 and the third drive portions 53 along the second direction Y have opposite phases, which can effectively increase the degree of symmetry of the differential signals of the three-axis gyroscope in the drive modality as shown in FIG. 2, FIG. 9 and FIG. 16 and reduce the influence of common mode interferences. In another aspect, the drive structure 5 is simple in structure, and can be stationary in the first detection modality, the second detection modality or the third detection modality, so that it is convenient for realizing mutual coupling of the first sensitive structure 1, the second sensitive structure 2 and the third sensitive structure 3 in the first detection modality, the second detection modality or the third detection modality, avoiding a large coupling error, and improving the detection accuracy of the three-axis gyroscope.

In one specific embodiment, as shown in FIG. 1, FIG. 8 and FIG. 15, the drive structure 5 further includes drive electrodes 54. The drive electrodes 54 are mounted on the first drive portions 51 and the second drive portions 521. The drive electrodes 54 are spaced apart from the first drive portions 51 and/or the third drive portions 53 to form drive capacitance.

In this embodiment, when the three-axis gyroscope is turned on, the drive capacitance of the drive electrodes 54 changes, so that the first drive portions 51 and the second drive portions 521 can drive the first sensitive structure 1 and the third sensitive structure 3 to move in the second direction Y. At the same time, the first drive portions 51 and the second drive portions 521 can drive the third drive portions 53 to drive the second sensitive structure 2 to rotate, so that the three-axis gyroscope is in the drive modality shown in FIG. 2, FIG. 9 and FIG. 16. Therefore, this structure is convenient for controlling the motions of the first sensitive structure 1, the second sensitive structure 2 and the third sensitive structure 3, and can simplify the structure of the drive structure 5, thereby simplifying the structure of the three-axis gyroscope and saving the installation space for the three-axis gyroscope.

The drive arms 52 can be fixed by fixing members 10, so that the drive arms 52 can rotate around the fixing members 10, which is convenient for realizing associated motions between the first drive portions 51, the second drive portions 521 and the third drive portions 53, and improving the stability of the three-axis gyroscope.

In one specific embodiment, as shown in FIG. 1, FIG. 8 and FIG. 15, the second sensitive structure 2 also includes rotational guide elastic members 25. The third mass block 21 and the fourth mass block 22 are provided with hole structures 26. The rotational guide elastic members 25 are located in the hole structures 26.

In this embodiment, the axis of each rotational guide elastic member 25 is fixed. In the driving modality as shown in FIG. 2, FIG. 9 and FIG. 16, the rotational guide elastic members 25 can guide the third mass block 21 and the fourth mass block 22 to rotate in a plane perpendicular to the third direction Z around the axes of the rotational guide elastic members 25. In the second detection modality as shown in FIG. 6 and FIG. 13, two ends of the rotational guide elastic members 25 along the second direction Y can rotate in the plane perpendicular to the first direction X with the third mass block 21 or the fourth mass block 22. Therefore, the arrangement of the rotational guide elastic members 25 improves the steadiness of the rotations of the third mass block 21 and the fourth mass block 22, thereby improving the stability of the three-axis gyroscope.

The foregoing is merely illustrative of embodiments of the present invention, and it should be noted that modifications may be made to those skilled in the art without departing from the spirit of the invention, but are intended to be within the scope of the invention.

What is claimed is:

1. A three-axis gyroscope, comprising a drive structure, a first sensitive structure, a second sensitive structure, and a third sensitive structure, wherein
the drive structure is used for driving the three-axis gyroscope;
the first sensitive structure is used for sensing an angular velocity in a first direction; the first sensitive structure is connected with the drive structure through elastic members; the first sensitive structure comprises a first mass block and a second mass block which are symmetrically arranged along a second direction;
the second sensitive structure is used for sensing an angular velocity in the second direction; the second sensitive structure is connected with the drive structure through elastic members; the second sensitive structure comprises a third mass block and a fourth mass block which are symmetrically arranged along the second direction;
the third sensitive structure is used for sensing an angular velocity in a third direction; the third sensitive structure is connected with the drive structure through elastic members; the third sensitive structure comprises a fifth mass block and a sixth mass block which are symmetrically arranged along the second direction, and a plurality of anchoring structures used for fixing the drive structure, the first sensitive structure, the second sensitive structure and the third sensitive structure;
wherein the first direction, the second direction and the third direction are orthogonal to each other; the three-axis gyroscope has a drive modality, a first detection modality, a second detection modality and a third detection modality;
in the drive modality, the drive structure drives the first mass block and the second mass block to move reversely along the second direction; each of the third mass block and the fourth mass block is provided with a rotating shaft having an extending direction parallel to the third direction; the drive structure also drives the third mass block and the fourth mass block to rotate reversely around respective rotating shafts towards the first sensitive structure or the third sensitive structure; the drive structure also drives the fifth mass block and the sixth mass block to move reversely along the second direction;
wherein when the third mass block and the fourth mass block rotate towards the fifth mass block and the sixth mass block, the fifth mass block and the sixth mass block are far away from each other, and the first mass block and the second mass block are close to each other; motion directions of the first mass block and the fifth mass block are opposite;
in the first detection modality, the drive structure, the second sensitive structure and the third sensitive structure remain stationary, and the opposite sides of the first mass block and the second mass block reversely flip towards the third direction to generate a vibration displacement in the third direction;
in the second detection modality, the drive structure, the first sensitive structure and the third sensitive structure remain stationary, and the third mass block and the fourth mass block reversely flip around the respective rotating shafts along the third direction to generate a vibration displacement in the third direction;
in the third detection modality, the drive structure, the first sensitive structure and the second sensitive structure remain stationary, and the fifth mass block and the sixth mass block reversely move along the first direction to generate a vibration displacement in the first direction.

2. The three-axis gyroscope according to claim 1, wherein the first sensitive structure further comprises a first guide portion; the first guide portion is connected to the anchoring structures through the elastic members along the first direction, and the first guide portion is connected to the first mass block or the second mass block through the elastic members along the second direction;
in the drive modality, the first guide portion is easily pulled by the first mass block and the second mass block to remain stationary, so as to prevent the first mass block and the second mass block from moving in the same direction along the second direction; and
in the first detection modality, the first guide portion is pulled by the first mass block and the second mass block to rotate towards the third direction.

3. The three-axis gyroscope according to claim 1, wherein the second sensitive structure further comprises a second guide portion; the second guide portion is connected to the anchoring structures through the elastic members along the first direction, and the second guide portion is connected to the third mass block or the fourth mass block through the elastic members along the second direction;
in the drive modality, the second guide portion is easily pulled by the third mass block and the fourth mass block to do reciprocating motion along the first direction, so as to prevent the third mass block and the fourth mass block from rotating in the same direction along the third direction; and
in the second detection modality, the second guide portion is pulled by the third mass block and the fourth mass block to do reciprocating motion along the third direction.

4. The three-axis gyroscope according to claim 1, wherein the third sensitive structure further comprises a third guide portion; the third guide portion is symmetrically provided with two first guide blocks along the first direction by taking the second direction as an axis of symmetry, and two second guide blocks along the second direction by taking the first direction as an axis of symmetry;
the first guide blocks are connected to the anchoring structures along the second direction through in-plane guide elastic members, and the opposite sides of the two first guide blocks are connected to the two second guide blocks through the elastic members;
the second guide blocks are connected to the anchoring structures along the first direction through the in-plane guide elastic members, and the reverse sides of the two second guide blocks are connected to the adjacent fifth mass block or sixth mass block through the elastic members;
in the drive modality, the second guide blocks are easily pulled by the fifth mass block and the sixth mass block to reversely move along the second direction, and the first guide blocks are easily pulled by the second guide blocks to reversely move along the first direction, thereby preventing the fifth mass block and the sixth mass block from moving in the same direction.

5. The three-axis gyroscope according to claim 1, wherein the third sensitive structure further comprises a first detection block and a second detection block which are symmetrically arranged along the second direction; the first detection block is connected to the anchoring structures along the second direction through the in-plane guide elastic members, and is connected to the fifth mass block along the first direction through the elastic member;
the second detection block is connected to the anchoring structures along the second direction through the in-plane guide elastic members, and is connected to the sixth mass block along the first direction through the elastic member;
in the drive modality, the first detection block and the second detection block remain stationary;
in the third detection modality, the first detection block moves with the fifth mass block in the same direction; and the second detection block moves with the sixth mass block in the same direction.

6. The three-axis gyroscope according to claim 4, wherein the third sensitive structure further comprises a first detection block and a second detection block which are symmetrically arranged along the second direction; the first detection block is connected to the anchoring structures along the second direction through the in-plane guide elastic members, and is connected to the fifth mass block along the first direction through the elastic member;
the second detection block is connected to the anchoring structures along the second direction through the in-plane guide elastic members, and is connected to the sixth mass block along the first direction through the elastic member;
in the drive modality, the first detection block and the second detection block remain stationary;
in the third detection modality, the first detection block moves with the fifth mass block in the same direction; and the second detection block moves with the sixth mass block in the same direction.

7. The three-axis gyroscope according to claim 4, wherein the third sensitive structure further comprises two third detection blocks, two fourth detection blocks and two coupling levers which are symmetrically arranged along the first direction by taking the second direction as an axis of symmetry, and the third detection blocks and the fourth detection blocks are symmetrically arranged one by one along the second direction by taking the first direction as an axis of symmetry;
along the first direction, one end of each of the two third detection blocks is connected with the fifth mass block through an elastic member, and the other end is connected with each coupling lever through an elastic member; one end of each of the two fourth detection blocks is connected with the sixth mass block through an elastic member, and the other end is connected with each coupling lever through an elastic member;
along the second direction, the two third detection blocks and the two fourth detection blocks are connected to the anchoring structures along the second direction through the in-plane guide elastic members;
in the drive modality, the third detection blocks and the fourth detection blocks remain stationary;
in the third detection modality, the two third detection blocks move in the same direction with the fifth mass block; the two fourth detection blocks move in the same direction with the sixth mass block; and the coupling levers are pulled by the third detection blocks and the fourth detection blocks to rotate in the same direction around rotating shafts of the coupling levers.

8. The three-axis gyroscope according to claim 1, wherein the three-axis gyroscope further comprises first transducers, second transducers, and third transducers;
along the third direction, the first transducers and the first sensitive structure are spaced apart to form capacitance to detect the vibration displacement of the first sensitive structure along the third direction, or to prevent an orthogonal error of the first detection modality, or to match the frequencies of the drive modality and the first detection modality;
along the third direction, the second transducers and the second sensitive structure are spaced apart to form capacitance to detect the vibration displacement of the second sensitive structure along the third direction (Z), or to prevent an orthogonal error of the second detection modality, or to match the frequencies of the drive modality and the second detection modality; and
in a plane perpendicular to the third direction, the third transducers and the third sensitive structure are located in the same plane, and the third transducers and the third sensitive structure are spaced apart to form capacitance to detect the vibration displacement of the third sensitive structure along the first direction, or to prevent an orthogonal error of the third detection modality, or to match the frequencies of the drive modality and the third detection modality.

9. The three-axis gyroscope according to claim 1, wherein the drive structure comprises first drive portions, drive arms, and third drive portions, and second drive portions are formed on the drive arms; the first drive portions and the third drive portions are respectively connected to both ends of the drive arms, and are respectively located on both sides of the second drive portions;
the first drive portions are connected with the first sensitive structure through elastic members; the second drive portions are connected with the second sensitive structure through elastic members; and the third drive portions are connected with the third sensitive structure through elastic members;
the first drive portions and the third drive portions are connected to the anchoring structures through in-plane guide elastic members along the first direction; and the first drive portions and the third drive portions drive the second drive portions to rotate through the elastic members when moving along the second direction.

10. The three-axis gyroscope according to claim 9, wherein the drive structure further comprises drive electrodes which are mounted on the first drive portions and the second drive portions; and
the drive electrodes are spaced apart from the first drive portions and/or the third drive portions to form drive capacitance.

11. The three-axis gyroscope according to claim 1, wherein the second sensitive structure further comprises rotational guide elastic members; the third mass block and the fourth mass block are provided with hole structures; and the rotational guide elastic members are located in the hole structures.
